(19) United States
(12) Patent Application Publication
(10) Pub. No.: US 2008/0107064 A1
(43) Pub. Date: May 8, 2008

(54) Media access server for satellite-based cellular networks

(75) Inventors: Neset Arda Erol, Vancouver (CA); Ronald McLeod, Richmond (CA)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom, Incorporated, Alameda, CA (US)

(21) Appl. No.: 11/593,933

(22) Filed: Nov. 6, 2006

(51) Int. Cl. H04B 7/185

(52) U.S. Cl. 370/316

(57) ABSTRACT

A system and method for processing media control traffic between a mobile switching center and plurality of remotely located media devices is described. The media devices are infrastructure components of a wireless network. The media control traffic includes a satellite link in the path between the mobile switching center and the media devices. The system and method use a media access server which is adapted for receiving media control messages from the mobile switching center for the plurality of media devices via the satellite link. The media access server acts as single a point of contact for media control messages between the mobile switching center and the plurality of media devices. In another implementation the media access server acts a single point of contact between the mobile switching center and a plurality of remote media devices, but a satellite link is not present between the mobile switching center and the media access server.

### BACKGROUND

1. Field

This invention relates generally to the field of wireless communications and more particularly to a method and apparatus for handling signaling traffic between a mobile switching center and remotely located media components of a wireless network over a satellite link.

2. Description of Related Art

It is known in the art that an Internet Protocol (IP) network can be used between two media gateways (MGWs) or Base Station Controllers (BSCs) or between an MGW and a BSC to carry media traffic from mobile terminals, such as cellular telephones, personal digital assistants, and the lap-top computers. Such media traffic is transported across networks in accordance with a protocol known as the Real-time Transport Protocol (RTP) as RTP streams. The Real-time Transport Protocol is a well known standard for transporting media streams in real time between endpoints such as roaming mobile devices.

Wireless service provider networks typically include infrastructure components such as media transcoders, media gateways, interactive voice response platforms, and others, which facilitate the providing of services or media for mobile terminals. Such components, referred to herein generally as “media devices”, are configured with hardware and software for generating and terminating media streams.

In some deployments of wireless networks, a satellite link is included in the communication path between a switching element of the wireless network, referred to herein as a mobile switching center, and the media devices. Such deployments may occur for example on an island, where the media devices and mobile terminals are on the island, but the mobile switching center is located on the mainland. In order to provide the media and services for the mobile terminal, the mobile switching center transmits media control messages to the media devices over the satellite link.

In many cases, protocols such as Media Gateway Control Protocol (MGCP), MEGACO and Session Initiation Protocol (SIP) are used to control the media devices. Regardless of the protocols used, when multiple media devices need to be controlled (e.g., to play an announcement to a cell phone user or to set up a conference call for the user), several messages need to be exchanged between the mobile switching center and the various media devices involved. The presence of satellites in the communication path can add significant delays to such media control. Such delays degrade the user experience. Usage of satellite links is also expensive and is generally billed based on the amount of data transferred.

There is a need in the art for a method and system more efficiently processing media control messages between a mobile switching center and remotely located media devices which reduces usage of satellite resources between the mobile switching center and the media devices and minimizes delays. This invention provides a media access server system and method that meets this need.

### SUMMARY OF THE INVENTION

The following embodiments and aspects thereof are described and illustrated in conjunction with systems, tools and methods which are meant to be exemplary and illustrative, not limiting in scope.

In one embodiment, a method is provided for processing media control traffic between a mobile switching center and plurality of remotely located media devices, the devices comprising infrastructure components of a wireless network. Such remotely located media devices are typically provisioned with software for either originating or terminating media streams. Examples of such media devices include a conference (or conference bridge) server, a media gateway, a media bridge, a media resource function, an Interworking Function (IWF), also referred to herein as Interworking Unit (IWU), a Base Station Controller (BSC), an interactive voice response (IVR) platform, and a media transcoder.

In the illustrated embodiments, the media control traffic includes a relatively slow and expensive satellite link in the path between the mobile switching center and the media devices. The inventive method and system includes a media access server which is used in processing media control traffic, but also which minimizes use of the satellite link. The media access server is connected to the media devices via a high-speed, typically land-based network, for example in the case where both the media access server and the media devices are located on the same island and are connected via a high speed network. This connection of the media access server and the media devices via a high speed network is referred to herein as “collocated.” The media devices need not be physically located at the same location or located in the same physical chassis as the media access server.

The media access server receives media control messages from the mobile switching center via the satellite link. Such media control messages may take a variety of forms, such as media control messages to play an announcement for a wireless terminal, provide media to the wireless terminal, set up a conference bridge for the wireless terminal, transcode media for the wireless terminal or other. Such messages may take the form of media gateway control (MEGACO) (ITU-T H.228) messages. The ITU-T H.228 specification is incorporated by reference herein. The media access server acts as single a point of contact for the media control messages between the mobile switching center and the plurality of media devices. In operation, the media access server receives a media control message for one or more of the media devices from the mobile switching center. The media access server then exchanges communication with the remotely located media components relating to the media control message, typically over a high speed land-based network such as a packet switched network. Such messages may use various protocols, such as Session Initiation Protocol (SIP), MEGACO, Media Gateway Control Protocol (MGCP), or other. The media access server further provides a response to the media control message on behalf of the remotely located media devices.

The usage of the satellite link is reduced from what it otherwise would be if the mobile switching center communicated directly with the media devices over the satellite link, as will be illustrated by several examples in the detailed description below.

Consider a first example wherein the media control message received by the media access server includes information for two or more of such remotely located media devices (media devices “A” and “B”). A single consolidated media control message including information for both devices A and B can be sent from the mobile switching center to the media access server over the satellite link. The media access server then forwards the relevant information in the media control message to each of the media devices “A and “B”. The media access server then receives responses from the media devices and then consolidates the responses into a single combined response, which may consist of the responses from both devices “A” and “B”, or simply an “ok” response, and transmits the combined response to the mobile switching center.

Further aspects of the invention are directed to a media access server for performing the methods described herein, and to a wireless service provider system including a media access server, mobile switching center and remotely located media devices.

In addition to the exemplary aspects and embodiments described above, further aspects and embodiments will become apparent by reference to the drawings and by study of the following detailed descriptions. All questions regarding the scope of the invention are to be determined by reference to the appended claims.

### BRIEF DESCRIPTION OF THE DRAWINGS

Exemplary embodiments are illustrated in referenced figures of the drawings. It is intended that the embodiments and figures disclosed herein are to be considered illustrative rather than restrictive

FIG. 1 is an illustration of a wireless service provider system, including a mobile switching center, and media access server acting as a single point of contact between the mobile switching center and a plurality of remotely located media devices.

FIG. 1A is an illustration of a second embodiment where the media access server is connected to the mobile switching center of a land-based network, instead of via a satellite link as shown in FIG. 1.

FIG. 2 is an illustration of an alternative configuration of the media access server.

FIG. 3 is an illustration of the message flow between a mobile switching center and two remote media devices in accordance with prior art.

FIG. 4 is an illustration of the message flow between the mobile switching center, media access server, and two remotely located devices in accordance with the embodiment of FIG. 1 or 2; the message flow illustrates that a reduction in the use of satellite resources occurs as compared to FIG. 3.

FIG. 5 is a second example of a message flow between a mobile switching center and three remote media devices in accordance with prior art.

FIG. 6 is an illustration of the message flow between the mobile switching center, media access server, and three remotely located devices in accordance with the embodiment of FIG. 1 or 2; the message flow illustrates that a reduction in the use of satellite resources occurs as compared to FIG. 5.

### DETAILED DESCRIPTION

Overview and Network Architecture

This disclosure takes advantage of the appreciation that in many cases, media control messages that are exchanged between a mobile switching center and one remotely located media device (device “A”) carry information that is of importance to other remotely located media devices (devices “B” and “C”). Such information in the media control message can include, for example, codec lists, RTP port numbers, and Internet Protocol (IP) addresses. The use a media access server as described herein can be used to decrease the number and size of the mobile switching center-to-remote media device messages, in either direction, over a satellite link. Basically, the media access server functions to act as a single point of contact between the mobile switching center and the remotely located media devices, to manage local communication between the remotely located or deployed devices, and to consolidate response messages from the media devices into a single response message which is sent over the satellite link to the mobile switching center. In doing so, it reduces the use of satellite links for the exchange of information between the mobile switching center and the remotely located media devices.

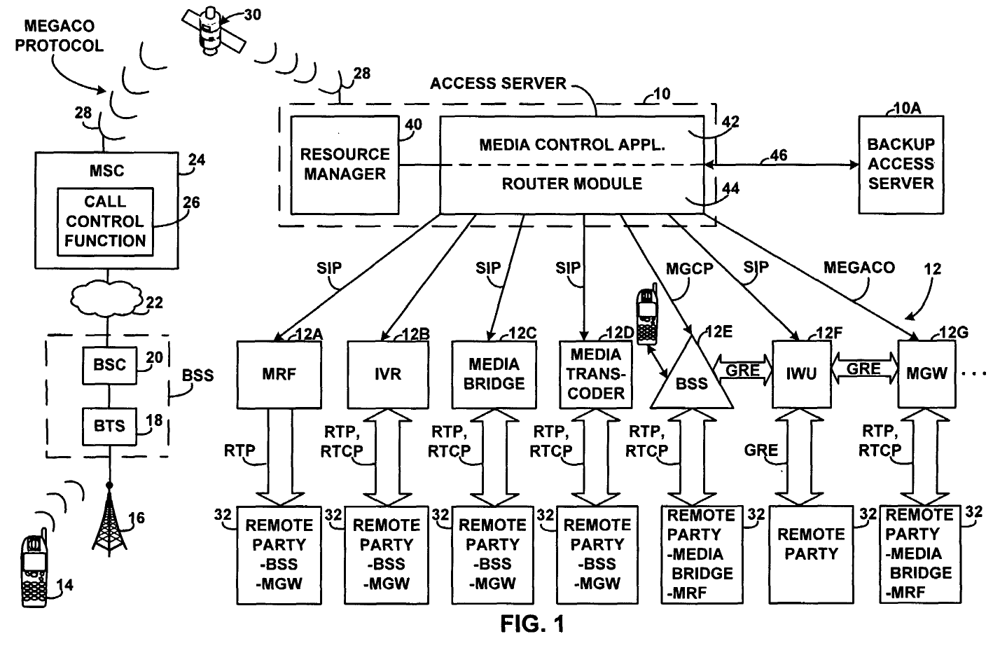

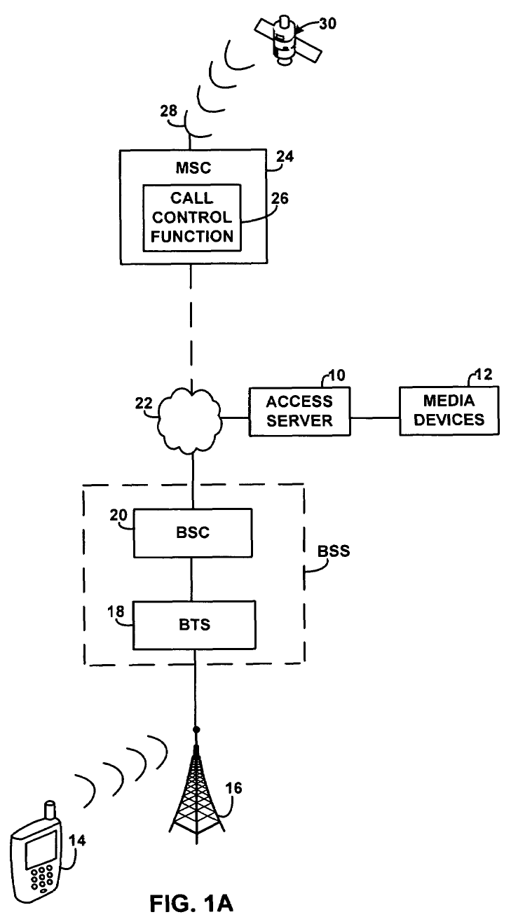

FIG. 1 is an illustration of a wireless service provider system, including a media access server 10 acting as a single point of contact between a mobile switching center 24 and a plurality of remotely located media devices 12A, 12B, 12C . . . 12G.

A mobile terminal 14 communicates in accordance with wireless protocol such as CDMA with a cellular telephony serving system including base transceiver station antenna 16, base transceiver station 18, and base station controller 20. These components are conventional. The base station controller 20 communicates over a network 22 with a mobile switching center 24. The mobile switching center 24 includes a call control function 26. The call control function 26 is used in a signaling and control path to facilitate providing media and/or services to the wireless mobile terminal 14. Call control function 26 forwards media control traffic from the mobile switching center 24 in accordance with MEGACO protocol over a satellite link 30 via satellite antenna 28 to a novel processing entity 10 referred to herein as a “media access server”.

The media access server 10 includes a media control application 42, a router module 44 and a resource manager 40. The details of the resource manager 40 are not pertinent to the present disclosure. The media access server may take the form a general purpose computing platform with interfaces to receive media control messages from the call control function 26 over a satellite link via antenna 28 and a network interface for forwarding media control message to remotely located media devices and receiving response messages from the media devices 12. The format or structure of the media access server 10 is not particularly important. A backup access server 10A may be provided, connected to access server 10 over a local area network 46.

The media control application (MCA) 42 is a software component within the media access server which functions as a single point of contact for media control messages from the MSC 24 or call control function 26, as described herein, and for managing the media related devices 12. The media control application 42 presents itself to the call control function 26 or MSC 24 as a single media gateway that is potentially capable of conferencing, V.32 modem data support, announcement and tone play, basic two-way media streaming, and other functions which are actually performed by the remotely located media devices 12. The extent of the media control application 42 capabilities depends on the capabilities of the media devices 12 deployed.

The media control application 42 can be controlled by one ore more call control functions 26. While FIG. 1 only shows one call control function (CCF) 26, multiple CCFs will typically be interacting with the media control application 42 at the same time in order to serve a distributed population of wireless terminals 14.

The router module 44 serves to forward media traffic received by the media control application 42 to remotely located media devices 12A . . . 12G, typically over land-based IP network using the protocols shown (SIP, MGCP or MEGACO). An optional backup media access server 10A is provided for failover and load balancing.

The media devices 12A . . . 12G may further communicate via RTP, RTCP, GRE or other protocols with remote entities 32, such as remote base station systems (BSS) forming a terminating system for the other party to the call, a remote media device such as a media gateway (MGW), media resource function, media bridge, etc., as shown in FIG. 1.

The various media devices 12 can take various forms and in general are network elements or infrastructure in a wireless service provider network. Such media devices can include the following:

Base Station System (BSS) (12E)

Base Station Systems provide connectivity to mobile phones. The anticipated protocols between the MCA 42 and various BSS implementations are MGCP and MEGACO. The MCA is designed to be able to handle either of these protocols and different vendor-specific implementations of each.

Media Gateway (MGW) (12G)

The Media Gateways provide connectivity to land-based phones. The anticipated protocols between the MCA and the various MGW implementations are MGCP and MEGACO. The MCA is designed to handle either of these protocols and different vendor-specific implementations of each.

Media Resource Function (MRF) (12A)

The Media Resource Function provides playback of prerecorded audio, such as announcements and call progress tones. The planned protocol between the MCA and the MRF is SIP with netann extensions.

Inter-Working Unit (IWU) (12F)

The Inter-Working Unit 12F provides support for data connectivity between two mobile phones, between a mobile phone and a legacy V.32 land modem, and between two V.32 land modems. In each case, the actual user data is tunneled across the IP network via GRE packets in a demodulated form. This approach minimizes the amount of data that needs to be carried over long distances. At each end of the call, user data is converted to a format that can be processed by the device on that end. This is GRE/IP for mobile phones, and V.32/TDM for land-based modems. The planned protocol between the MCA 42 and the IWU 12F is SIP with netann extensions.

Media Bridge (12C)

The Media Bridge provides conferencing (audio/video mixing) among three or more parties. Although it may be possible to use a Media Bridge when there are only two parties in a call, the MCA 42 ensures that the Media Bridge is removed from the media path whenever the number of participants in a call drops below 3 in order to free up Media Bridge resources. The planned protocol between the MCA and the Media Bridge is SIP with netann extensions. A more advanced conference control protocol may also be used on this interface.

Interactive Voice Response (IVR) Unit (12B)

The IVR unit 12B provides a platform for responding to speech of a user and may include a speech recognition engine, text to speech converter, and other components known in the art for forming interactive voice response services for a user in response to speech input.

Media Transcoder (12D)

The Media Transcoder converts compressed media packets (i.e. voice and/or video packets) from one compression format to another.

FIG. 1A shows an embodiment where a Media Access server 10 is placed in communication with a mobile switching center 24 via a land-based IP network 22. The access server 10 presents a single point of contact for one or more remotely-located media devices 12. In essence, all of the media devices 12A . . . 12G of FIG. 1 can can also be connected to network 22 and receive messages from the MSC 24 via the media access server 10. The access server 10 provides a higher-level, easier-to-use interface to the MSC 24. Once an MSC is built to communicate with a remote media access server using higher-level commands, as described herein, there is no need to add additional functionality to the MSC to be able to control media devices directly. Rather, the MSC exchanges high-level messages with the access server 10, which communicates directly with the media devices as explained below.

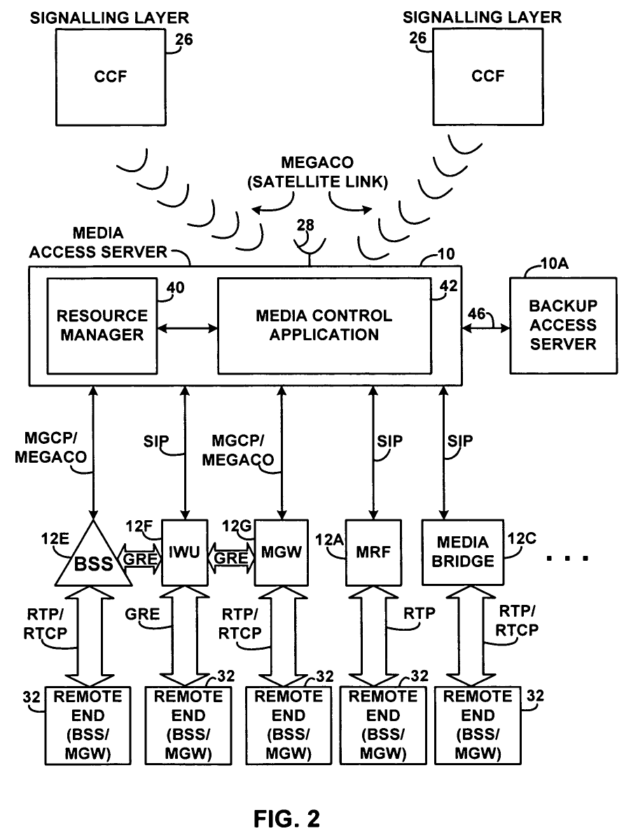

FIG. 2 is an illustration of an alternative configuration of the media access server 10. In the embodiment of FIG. 2, there is no central router module incorporated into the media access server 10 (shown at 44 in FIG. 1). In the embodiment of FIG. 2, routing capabilities are pushed towards the media devices 32. The router(s) are on the communications path between each media device 12 and its connection with the remote end 32. The router(s) can be an integral part of each media device 12.

Operation

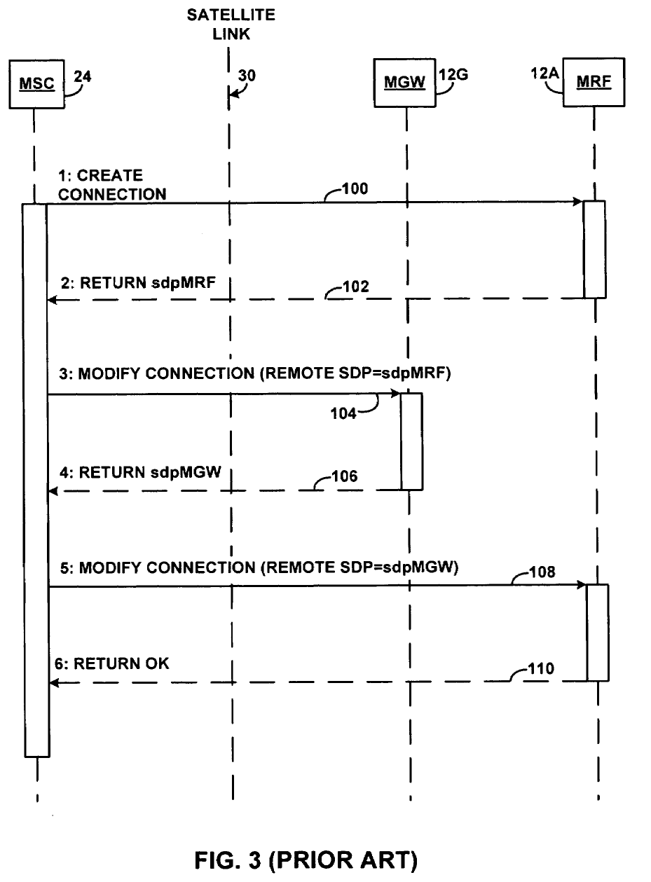

The operation of the media access server 10 of FIGS. 1 and 2 will now be described in further detail with reference to FIGS. 3-6. The description also applies to the embodiment of FIG. 1A.

### EXAMPLE 1

In order to appreciate the advantages of the system of FIGS. 1 and 2, consider first FIG. 3, which is an illustration of the message flow for media control messages between a mobile switching center 24 and two remote media devices 12G and 12A in accordance with prior art. In this example, somewhat simplified for purposes of illustration, a media connection setup is made between a media gateway MGW 12G and a media resource function MRF 12A. The message flow is such that the operator of the system wants to break this connection and play an announcement to the user of a land (wired) phone connected to MGW 12G (FIG. 1). It could also be a wireless phone on another service provider's network that is connected to the network in question via MGW 12G (if MGW 12G is a trunking media gateway). The announcement will be played from a MRF media device 12A. The messages shown in FIG. 3 are conceptual, and can be mapped to any one of MEGACO, MGCP, or SIP protocols, the selection of which depends on what protocol is supported on each media device 12A and 12G. For example, the MGW 12G may support MGCP whereas the MRF may support SIP only. The diagram of FIG. 3 shows the theoretically minimum amount of messaging, regardless of the protocol. Extra details that are irrelevant, such as announcement ID, are omitted.

The messages shown in FIG. 3 can include a create connection message 100 exchanged between the MSC 24 and the MRF 12A. A return response message 102 “return sdpMRF” is generated at the MRF 12A and sent back to the MSC 24. Next, a modify connection message 104 is sent by the MSC 24 to the MGW 12G, and the MGW 12G generates and transmits a return message 106 to the MSC 24. Then, a modify connection message is sent 108 from the MSC to the MRF 12A, and the MRF 12A generates a return ok message 110. The messages 100, 102, 104, 106, 108, and 110 all make use of the satellite link 30, which adds noticeable latency to the user.

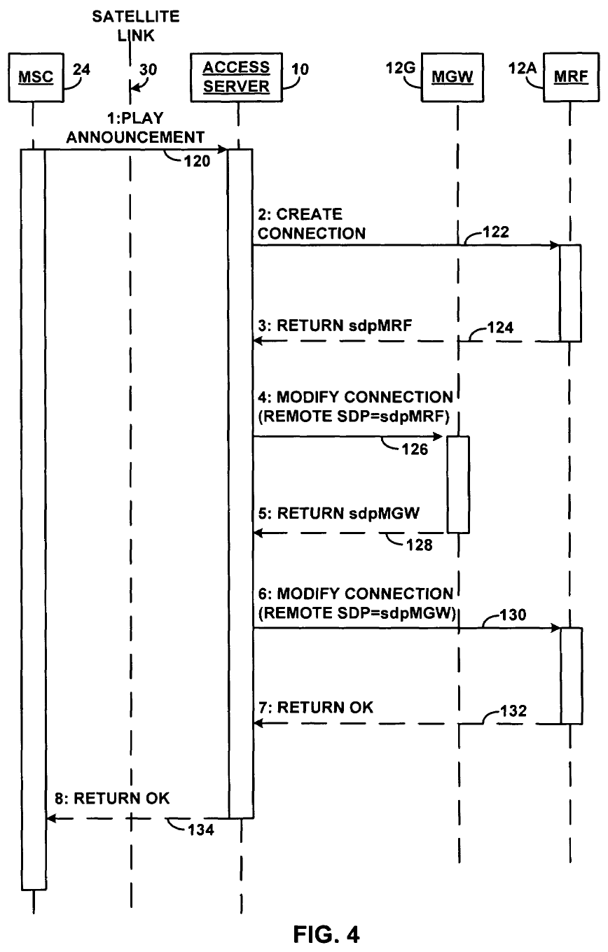

Compare the prior art message flow of FIG. 3 with the situation shown in FIG. 4 in accordance with one aspect of this disclosure. A high-level media control message in the form of a play announcement message 120 is sent from the MSC 24 to the media access server 120, over the satellite link 30. The play announcement message is a high-level message that tells the media access server 10 and associated media devices 12 to play an announcement or tone identified by an announcement ID. In this example, MEGACO is the protocol between the MSC 24 and the media access server 10, therefore the play announcement message could be a “tonegen”-derived or “cg” package signal, see MEGACO (ITU-T H.228) Tone Generation and Call Progress Tones Generator packages for further details. MEGACO also allows extending packages, so the entity instituting this invention can define message packages for any message between the MSC and the access server when no existing package meets the messaging requirements at hand.

The media control application 42 in the access server then sends a create connection message 122 to the MRF and receives a response message 124, sends a modify connection message 126 to the MGW 126 and receives a return message 128, and sends a modify connection message 130 to the MRF 12A and receives a return OK message 132. Messages 122, 124, 126, 128, 130, and 132 of FIG. 4 correspond to messages 100, 102, 104, 106, 108, and 110 of FIG. 3. However, messages 122, 124, 126, 128, 130, and 132 do not make any use of the satellite link. The access server 10 consolidates the response messages 124, 128 and 132 and generates a single consolidated response message 134, e.g., a “return ok” message 134, over the satellite link 30 to the MSC 24. The result is reduction in latency and improved user experience since in the message flow of FIG. 4 only two messages are exchanged over the satellite link (120 and 134) whereas in FIG. 3 at least six messages were exchanged over the satellite link (100, 102, 104, 106, 108 and 110).

### EXAMPLE 2

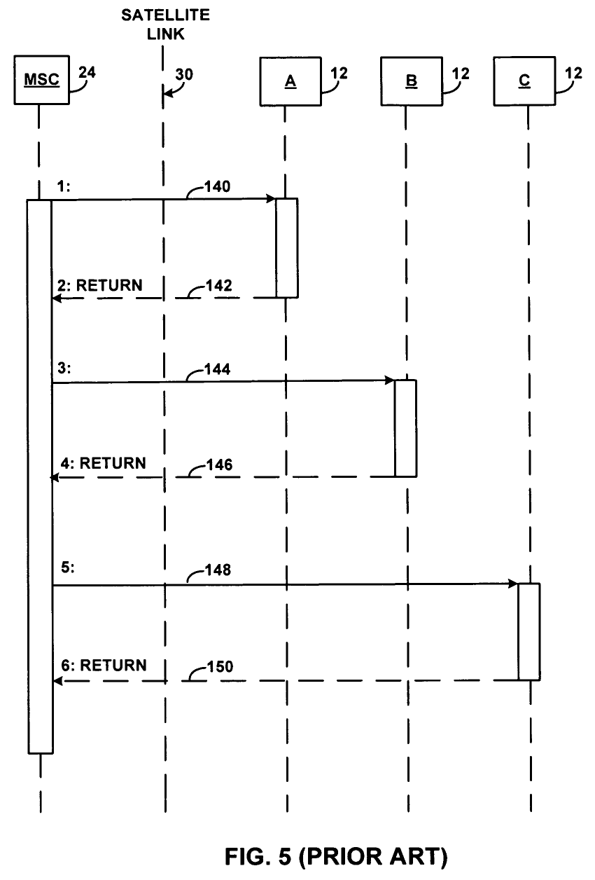

FIG. 5 is a second example of a message flow between a mobile switching center and three remote media devices in accordance with prior art. In this example, the MSC exchanges media control messages with media devices 12 (devices “A,” “B” and “C”). B and C are co-located with A. The details in the messages are not particularly important. Message 140 could be for example a create connection message, and the media device A includes a return result response 142. The MSC 24 then generates a second message 133 to device B and receives a return result message 146. The MSC then generates a third message 148 and transmits it to media device C and receives a return result message 150. All messages 140, 142, 144, 146, 148 and 150 are sent over a satellite link, with associated delay.

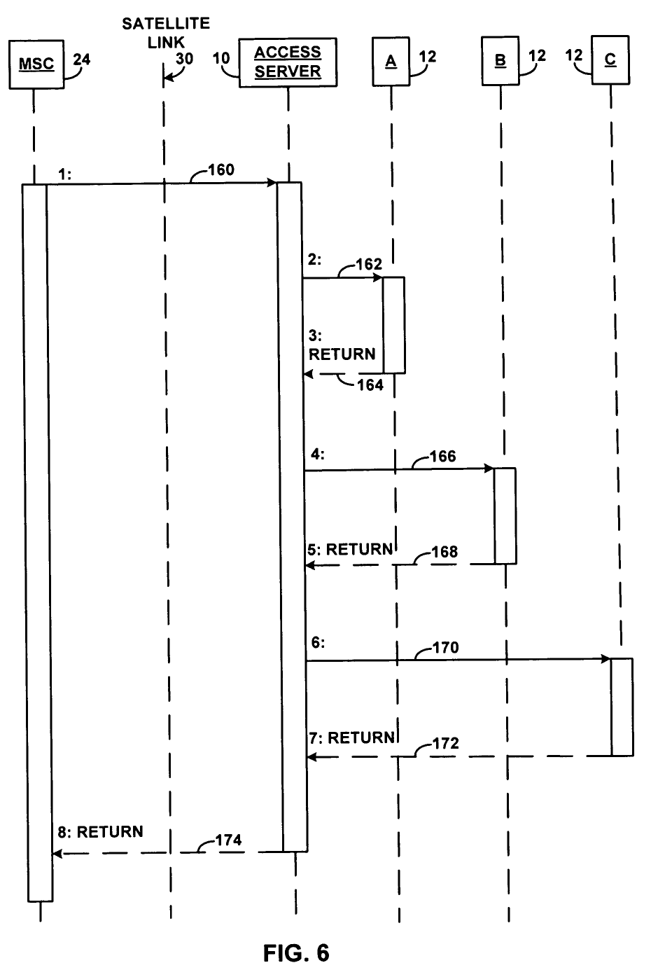

FIG. 6 is an illustration of the message flow between the mobile switching center 24, media access server 10, and remotely located devices (12) A, B and C in accordance with the embodiment of FIG. 1 or 2. The message flow illustrates that a reduction in the use of satellite resources occurs as compared to FIG. 5. In particular, a media control message 160 such as “play announcement,” “bridge conference,” “transcode media”, etc. is sent over the satellite link from the MSC 24 to the media server 10. The message 160 includes all the information contained in messages 140, 144, and 148 of FIG. 3. The media access server 10 extracts such information and generates messages 162, 166 and 170 (corresponding to messages 140, 144 and 148 of FIG. 5, respectively) and receives return result messages 164, 168 and 172 as shown (corresponding to messages 142, 146 and 150 of FIG. 5, respectively). The media access server sends a single consolidated return result message 174 to the MSC 24, over the satellite link. By comparing FIG. 6 to FIG. 5, it is apparent that usage of the satellite link 30 is significantly reduced (only 2 messages as compared to 6 messages as shown in FIG. 5). Moreover, since messages 162-172 are transmitted over faster land-based networks connecting the media access server and the media devices, the result is less delay than the message flow of FIG. 5. Again, the message flow of FIGS. 5 and 6 is intended to illustrate the overall concepts involved, and the particulars are not particularly important and will depend on the protocols used.

In the situation where the media control message is of relevance only to one remotely located media device 12 (“A”), the media access server 10 acts merely as a proxy between the MSC 24 and the media device A.

While the above examples have used tone generation and announcements as the type of services performed by the media devices 12, other functions of course will be performed depending on the particular media device 12 in question.

From the foregoing discussion, it is thus apparent that a method has been described for processing media control traffic between a mobile switching center 24 and plurality of remotely located media devices 12, the devices comprising infrastructure components of a wireless network. Such remotely located media devices are typically provisioned with software for either originating or terminating media streams. Examples of such media devices include a conference (or conference bridge) server, a media gateway, a media bridge, a media resource function, an Interworking Function (IWF), also referred to herein as Interworking Unit (IWU), a Base Station Controller (BSC), an interactive voice response (IVR) platform, and a media transcoder, as shown in FIGS. 1 and 2.

In the illustrated embodiments, the media control traffic includes a relatively slow and expensive satellite link 30 in the path between the mobile switching center 24 and the media devices 12. The inventive method and system includes a media access server 10 which is used in processing media control traffic but also which minimizes use of the satellite link.

The media access server receives media control messages from the mobile switching center 24 for the plurality of media devices via the satellite link 30, e.g., message 160 of FIG. 6 and message 120 of FIG. 4. Such media control messages may take a variety of forms, such as media control messages to play an announcement for a wireless terminal, provide media to the wireless terminal, set up a conference bridge for the wireless terminal, transcode media for the wireless terminal or other. Such messages 120, 160 may take the form of media gateway control (MEGACO) (ITU-T H.228) messages. The media access server 10 acts as single a point of contact for media control messages between the mobile switching center 24 and the plurality of media devices 12. In operation, the media access server receives a media control message for one or more of the media devices from the mobile switching center. The media access server 10 then exchanges communication with the remotely located media components 12 relating to the media control message, typically over a high speed land-based network such as a packet switched network, as shown in FIGS. 4 and 6. Such messages may use various protocols, such as Session Initiation Protocol (SIP), MEGACO, Media Gateway Control Protocol (MGCP), or other. The media access server further provides a response to the media control message (174 of FIG. 6 or 134 of FIG. 4) to the mobile switching center on behalf of the remotely located media devices 12.

The usage of the satellite link is reduced from what it otherwise would be if the mobile switching center communicated directly with the media devices over the satellite link, as described above in the discussion of FIGS. 3-6.

As discussed in the example of FIG. 4, the media control message 120 received by the media access server 12 may include information for two or more of such remotely located media devices 12G and 12A (media devices “A” and “B”). A single consolidated media control message 120 including information for both devices A and B can be sent to the media access server over the satellite link. The media access server then forwards the relevant information in the media control message to each of the media devices “A and “B”. The media access server then receives responses from the media devices (124, 128 and 132) and then consolidates the responses into a single response 134 and transmits the response to the mobile switching center 124. Media devices A and B can be co-located or on separate processing platforms.

From the foregoing, it will also be appreciated that a system shown in FIGS. 1 and 2 has been described for processing media control traffic between a mobile switching center 24 and plurality of remotely located media devices 12 comprising infrastructure components of a wireless network. The media control traffic includes a satellite link 30 in the path between the mobile switching center 10 and the media devices 12. The system includes a media access server 10 adapted for receiving media control messages from the mobile switching center 24 for the plurality of media devices 12 via the satellite link 30, whereby the media access server 10 acts as single a point of contact for media control messages between the mobile switching center 24 and the plurality of media devices 12. The media access server 10 receives a media control message for one or more of the media devices from the mobile switching center 24, as shown for example in FIGS. 4 and 6 at 120 and 160. The media access server 10 is configured with software and an interface, shown as the media control application 42, for exchanging communication between the media access server and remotely located media components 12 relating to the media control message. The media access server is further configured with software and an interface in the media control application 42 for providing a response to the media control message from the media access server to the mobile switching center 24, as shown in FIGS. 4 and 6 at 134 and 174, whereby usage of the satellite link 30 may be reduced as explained above.

From the foregoing, it will be further understood that a wireless service provider system has been described comprising a media access server 10, a plurality of remotely located media devices 12 comprising infrastructure components of wireless communication network, and a mobile switching center 24 transmitting media control traffic to the media access server 10. The media control traffic includes a satellite link 30 in the path between the mobile switching center 24 and the media devices 12. The media access server 10 is adapted for receiving media control messages from the mobile switching center 24 for the plurality of media devices 12 via the satellite link 30, whereby the media access server acts as single a point of contact for media control messages between the mobile switching center 24 and the plurality of media devices 12. The media access server receives a media control message for one or more of the media devices from the mobile switching center, exchanges communication between the media access server and remotely located media components relating to the media control message, and provides a response to the media control message from the media access server to the mobile switching center 24, whereby usage of the satellite link may be reduced as illustrated in FIGS. 3-6.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

We claim:

1. A method for processing media control traffic between a mobile switching center and plurality of remotely located media devices comprising infrastructure components of a wireless network, said media control traffic including a satellite link in the path between the mobile switching center and the media devices, comprising the steps of:
providing a media access server for receiving media control messages from the mobile switching center for the plurality of media devices via the satellite link, whereby the media access server acts as a single a point of contact for media control messages between the mobile switching center and the plurality of media devices;
receiving a media control message for one or more of the media devices from the mobile switching center at the media access server;
exchanging communication between the media access server and remotely located media components relating to the media control message; and
providing a response to the media control message from the media access server to the mobile switching center, whereby usage of the satellite link may be reduced.

2. The method of claim 1, wherein the media devices comprise one or more of a conference server, a media gateway, a media bridge, a media resource function, an Interworking Function (IWF), a Base Station Controller (BSC), an interactive voice response unit, and a Media Transcoder.

3. The method of claim 1, wherein the media control message received by the media access server includes information for two or more of such remotely located media devices; and wherein the method further comprises the steps of:
forwarding said information from said media access server to said media devices;
receiving responses from said devices at said media access server; and
consolidating said responses in said media access server into a combined response message to the mobile switching center.

4. A system for processing media control traffic between a mobile switching center and plurality of remotely located media devices comprising infrastructure components of a wireless network, comprising:
a media access server adapted for receiving media control messages from the mobile switching center for the plurality of media devices, whereby the media access server acts as single a point of contact for media control messages between the mobile switching center and the plurality of media devices;
said media access server receiving a media control message for one or more of the media devices from the mobile switching center;
said media access server configured with software and an interface for exchanging communication between the media access server and remotely located media components relating to the media control message; and
said media access further configured with software and an interface for providing a response to the media control message from the media access server to the mobile switching center.

5. The system of claim 4, wherein the media devices comprise one or more of a conference server, a media gateway, a media bridge, a media resource function, an Interworking Function (IWF), a Base Station Controller (BSC), an interactive voice response unit and a Media Transcoder.

6. The system of claim 4, wherein the media control message received by the media access server includes information for two or more of such remotely located media devices; and wherein the media access server is configured to forward said information to said media devices; receive responses from said devices, and consolidate said responses into a combined response message to the mobile switching center.

7. The system of claim 4, wherein said media control traffic includes a satellite link in the path between the mobile switching center and the media devices.

8. A wireless service provider system, comprising
a media access server;
a plurality of remotely located media devices comprising infrastructure components of wireless communication network,
a mobile switching center transmitting media control traffic to the media access server, said media control traffic including a satellite link in the path between the mobile switching center and the media devices,
wherein said media access server is adapted for receiving media control messages from the mobile switching center for the plurality of media devices via the satellite link, whereby the media access server acts as single a point of contact for media control messages between the mobile switching center and the plurality of media devices;
said media access server receiving a media control message for one or more of the media devices from the mobile switching center;
said media access server configured with software and an interface for exchanging communication between the media access server and remotely located media components relating to the media control message; and
said media access further configured with software and an interface for providing a response to the media control message from the media access server to the mobile switching center, whereby usage of the satellite link may be reduced.

9. A method for processing media control traffic between a mobile switching center and plurality of remotely located media devices comprising infrastructure components of a wireless network, comprising the steps of:
providing a media access server for receiving media control messages from the mobile switching center for the plurality of media devices, whereby the media access server acts as single a point of contact for media control messages between the mobile switching center and the plurality of media devices;
receiving a media control message for one or more of the media devices from the mobile switching center at the media access server;
exchanging communication between the media access server and remotely located media components relating to the media control message; and
providing a response to the media control message from the media access server to the mobile switching center.

10. The method of claim 9, wherein the media control message received by the media access server includes information for two or more of such remotely located media devices; and wherein the method further comprises the steps of:
forwarding said information from said media access server to said media devices;
receiving responses from said devices at said media access server; and
consolidating said responses in said media access server into a combined response message to the mobile switching center.
